(19) United States
(12) Patent Application Publication
(10) Pub. No.: US 2017/0081219 A1
(43) Pub. Date: Mar. 23, 2017

(54) REACTOR DEVICE FOR USE WITH WATER REMEDIATION AND TREATMENT SYSTEMS AND METHOD FOR REMEDIATING AND/OR TREATING AQUEOUS PROCESS STREAMS

(71) Applicant: Adam Taylor, Troy, MI (US)

(72) Inventor: Adam Taylor, Troy, MI (US)

(21) Appl. No.: 15/274,317

(22) Filed: Sep. 23, 2016

Related U.S. Application Data
(60) Provisional application No. 62/355,864, filed on Jun. 28, 2016.
(60) Provisional application No. 62/233,431, filed on Sep. 27, 2015.
(60) Provisional application No. 62/222,764, filed on Sep. 23, 2015.

(51) Int. Cl. C02F 1/463; C02F 1/461; C02F 1/00

(52) U.S. Cl. CPC C02F 1/463; C02F 1/004; C02F 1/46104; C02F 2103/10

(57) ABSTRACT

A water remediation treatment device and system that can be used in various applications including, but not limited agriculture and aquaculture operations such as commercial fish and/or crustacean farming. The device disclosed herein includes at least one reaction unit. The reaction unit includes housing having an interior chamber accessible by a fluid inlet and a fluid outlet. The housing includes means for defining a fluid flow path within the housing and a plurality of electrodes operatively positioned in the fluid flow path, wherein at least a portion of the electrodes are oriented in a circular or semicircular relationship relative to one another. In certain embodiments, at least a portion of the electrodes are oriented in a spiral relationship relative to one another and are oriented at an angle relative to the fluid flow path. In certain embodiments, the electrode can function either anodicly or cathodicly depending on suitable inputs.

### CROSS REFERENCE TO RELATED APPLICATIONS

The present invention claims priority to U.S. Ser. No. 62/222,764, filed Sep. 23, 2015; U.S. Ser. No. 62/233,431, filed Sep. 27, 2015; and U.S. Ser. No. 62/355,864, filed Jun. 28, 2016, all currently pending, the specification of which are incorporated by reference in their entirety.

### BACKGROUND

The present invention relates to methods and devices for water treatment and for water remediation.

The need to treat and remediate process water is well-appreciated in a wide variety of applications both to insure the quality of incoming water and to treat and/or remediate process water produced or employed in various industries including, but not limited to, aquaculture, terrestrial agriculture as well as process water used oil production and hydrofracking, process water used in various surface treatment processes, various cleaning procedures producing grey water and the like. Various methods and devices have been proposed. However, the need to provide effective, energy efficient devices, systems and subsystems for water treatment and remediation is still largely unmet.

It would be desirable to provide a device for water remediation and treatment that was robust, effective, energy efficient and can be used in a variety of applications. It is also desirable to provide a device that can be used as a subsystem for use in various water remediation and/or treatment systems.

### SUMMARY

Disclosed herein is a water remediation treatment device and system that can be used in various applications including, but not limited agriculture and aquaculture operations such as commercial fish and/or crustacean farming. The device disclosed herein includes at least one reaction unit. The reaction unit includes housing having an interior chamber accessible by a fluid inlet and a fluid outlet. The housing includes means for defining a fluid flow path within the housing and a plurality of electrodes operatively positioned in the fluid flow path, wherein at least a portion of the electrodes are oriented in a circular or semicircular relationship relative to one another. In certain embodiments, at least a portion of the electrodes are oriented in a spiral relationship relative to one another and are oriented at an angle relative to the fluid flow path. In certain embodiments, the electrode can function either anodicly or cathodicly depending on suitable inputs.

The reactor unit also include also include at least one gas inlet and gas outlet. The inlet is typically configured for introducing a suitable reactive gas into the process stream proximate to the process stream inlet port. The gas outlet is configured and located distal to the gas inlet convey spent gas and excess reaction gas from the reactor unit. The reactor unit also includes at least one contaminant outlet that configured to convey isolated contaminants and reacted contaminant material away from the reactor unit.

### BRIEF DESCRIPTION OF THE DRAWING

In the present disclosure reference is made to the following various drawings in which like reference numerals are used for like elements throughout the various figures. The drawing figures are for illustrative purposes only and include the following:

FIG. 1 is side view in partial cutaway of an embodiment of a water treatment/remediation reactor unit as disclosed herein;

FIG. 2 is a perspective view of the embodiment of FIG. 1 with the associated housing shown in phantom;

FIG. 2 is a perspective view of the water treatment/remediation reactor unit of FIG. 1 with electrodes in in partial cutaway;

FIG. 4 top view of the water treatment/remediation reactor unit of FIG. 1 with the associated top plate fitting removed;

FIG. 5A is a schematic diagram of an electrode orientation pattern for use in the embodiment of FIG. 1 shown relative to an embodiment of a gas introduction device as disclosed herein;

FIG. 5B is a detail view of a portion of an embodiment of the electrodes of FIG. 5A;

FIG. 6 is a schematic diagram of an alternate electrode orientation pattern for use in the embodiment of FIG. 1 shown relative to an embodiment of a gas introduction device as disclosed herein

FIG. 7 is a schematic depiction of the water treatment/remediation reactor unit of FIG. 1 illustrating representative water, reaction gas and contaminant flow paths with the electrodes in partial cutaway;

FIG. 8 is a perspective view of the water treatment/remediation reactor unit flow path of FIG. 1 illustrating a representative water flow path with the electrodes in phantom in partial cutaway;

FIG. 9 is a top view of the device illustrated in FIG. 7 illustrating a represented cross sectional flow path of the process stream;

FIG. 10 is a perspective view of an embodiment of an electrode employed in the water treatment/remediation reactor unit as disclosed herein;

FIG. 11 is a plan view of the electrode of FIG. 10;

FIG. 12 is a side plan view of the electrode of FIG. 11;

FIG. 13 is a cross-sectional view taken through the 13-13 line of FIG. 11;

FIG. 14 is a detail view of an embodiment of a reaction gas inlet diffuser employed in the water treatment/remediation reactor unit of FIG. 1;

FIG. 15 is a plan view of the diffuser of FIG. 14;

FIG. 16 is a side view of the diffuser of FIG. 14;

FIG. 17 is a schematic diagram of the process occurring in the water treatement/remediation reactor unit of FIG. 1;

FIG. 18 is a perspective view of the outer housing of the device of FIG. 1;

FIG. 19 is a partial side view of an embodiment of an electrode array that can be employed in the water treatment/remediation reactor unit of FIG. 1;

FIG. 20 is a top view of the device of depicted in FIG. 1 depicting a representative radial fluid flow path occurring therein;

FIG. 21 is a perspective view of the electrode array of FIG. 19; and

FIG. 22 is a perspective view of unit that employing the water treatment/remediation reactor unit disclosed herein;

FIG. 23 is a top plan view of the unit of FIG. 22;

FIG. 24 is a process diagram of an embodiment of the water treatment/remediation method as disclosed herein;

FIG. 25 is a schematic diagram of an embodiment of the water remediation method and devices as disclosed herein;

FIG. 26 is a screen capture of the user interface of an embodiment of a water treatment/remediation device as disclosed herein implementing an embodiment of the advanced linear electro-floatation method as disclosed herein a main point;

FIG. 27 is a screen capture of the user interface of an embodiment of a water treatment/remediation device as disclosed herein implementing an embodiment of the advanced linear electro-floatation method as disclosed herein outlining system setpoints;

FIG. 28 is a screen capture of the user interface of an embodiment of a water treatment/remediation device as disclosed herein implementing an embodiment of the advanced linear electro-floatation method as disclosed herein outlining system information;

FIG. 29 is a screen capture of the user interface of an embodiment of a water treatment/remediation device as disclosed herein implementing an embodiment of the advanced linear electro-floatation method as disclosed herein outlining alarm history;

FIG. 30 is a screen capture of the user interface of an embodiment of a water treatment/remediation device as disclosed herein implementing an embodiment of the advanced linear electro-floatation method as disclosed herein outlining alarm maintenance information;

FIG. 31 is a screen capture of the user interface of an embodiment of a water treatment/remediation device as disclosed herein implementing an embodiment of the advanced linear electro-floatation method as disclosed providing interface with various processes.

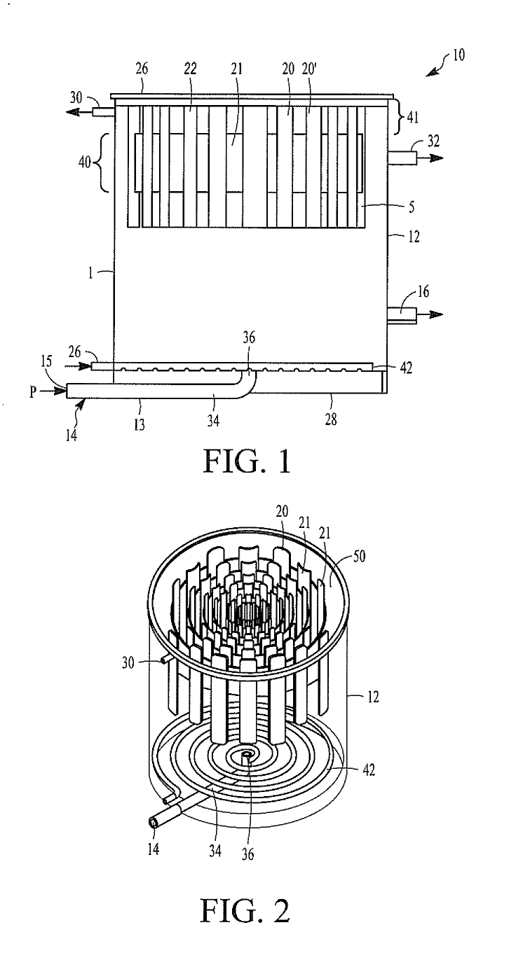

### DETAILED DESCRIPTION

Disclosed herein is a water remediation and treatment device and components that can be employed to reduce and/or eliminate at least one target contaminant present in an aqueous stream as well as a method for accomplishing the same. As broadly disclosed herein, the device includes at least one water treatment/remediation reactor unit positioned in contact with a process stream to be treated. Also disclosed is a water treatment/remediation rector chamber that configured to induce turbulent flow in the introduced aqueous process stream and promote contact between contaminants present in the aqueous stream and electroactive surfaces of electrodes present within the reaction chamber. The contaminants present in the aqueous stream can also be brought into contact with oxygen present in the process stream, a portion of which can be introduced to induce or promote turbulent flow. It has been discovered that the method and device as disclosed herein can be effectively employed or salt water.

It is contemplated that the process as disclosed herein is a method which can pretreat water prior to usage or can be employed for post usage aqueous material such as effluent or the like. The aqueous material that is treated can include one or more target contaminants including, but not limited to fecal matter, other biologically derived material, one or more heavy metals, and organic chemicals including but not limited to pesticides and the like. It has been found, quite unexpectedly that the process disclosed herein utilizes and addresses specific characteristics and challenges found and presented by aquaculturing operations; particularly those occurring in salt water environments. It has long been recognized that the present of the elevated levels of chlorine compounds in salt water present enhanced problems during water remediation process. These can include the generation and removal of hydrogen, chlorine and the like.

The method and device as disclosed herein can function as an efficient cost-effective water treatment and remediation system for use in a variety of industries and applications, including but not limited to, oil and gas production, metal plating operations, acid mine drainage, agricultural operations, textile treatment, heavy manufacturing operations and the like. the process and device can be employed to treat a wide range of industrial, agricultural and commercial waste streams contaminated with heavy metals, microorganisms, bacteria, pesticides, arsenic, MTBE, cyanide, biological oxygen demand (BOD), total dissolved solids (TDS), total suspended solids (TSS), nitrogen, phosphate, and other biological nutrients and has been suggested as a cost effective, efficient method for coagulation of organic and biologically derived materials such as algae biomass for first stage pre-concentration and dewatering.

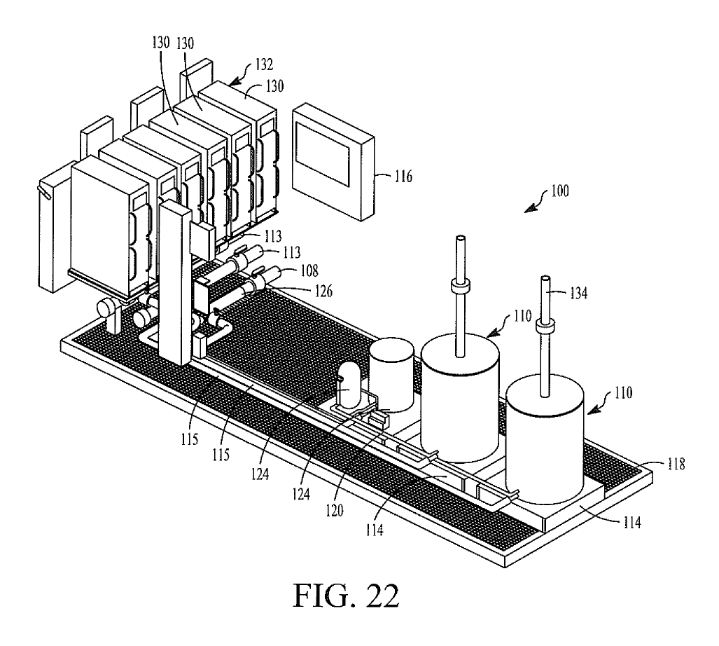

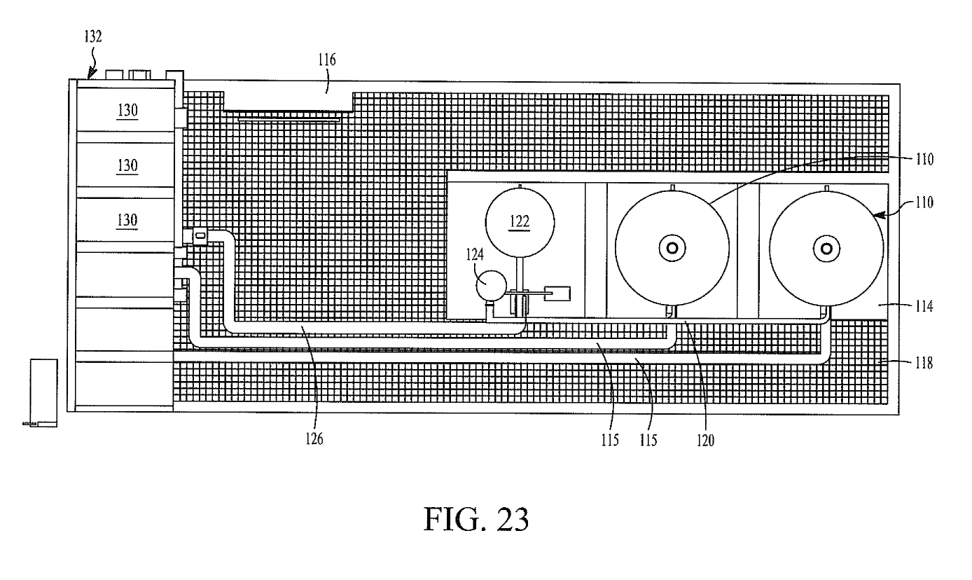

Disclosed herein is a water treatment/remediation reactor unit 10 that can be configured as a stand-alone unit or be utilized as part of an associated water remediation and treatment device, a non-limiting embodiment of a water remediation and treatment device 100 is depicted in FIGS. 22 and 23.

The water treatment/remediation reactor unit 10 as broadly disclosed includes a reactor housing 12 that defines interior chamber 18. Interior chamber 18 can have a suitable volume to provide the desired capacity throughput. In certain embodiments, the interior chamber 18 will have an interior volume that is between 20 cubic inches and 400 cubic inches, with volumes between 30 cubic inches and 100 cubic inches being employed in some embodiments; and volumes between 40 and 80 cubic inches being employed in certain embodiments.

A process fluid inlet assembly 14 provides fluid access to the interior chamber 18. The process fluid inlet assembly 14 can include a central conduit 13 having a first end 15 that is or can be placed in fluid communication with a source of water to be processed (not shown). The first end 15 of central conduit 13 can connect with a suitable water conveying conduit (not shown) via any suitable device. The second end 17 of central conduit 13 can connect to the interior chamber 18 and can have a fluid directing region can have a curved region 19. The reactor housing 12 also includes a treated water outlet 16 defined in the reactor housing 12 at a location located distinct from the process fluid inlet assembly 14. The treated water outlet 16 is or can be placed in fluid communication with a suitable treated water receptacle or outlet (not shown).

The water treatment/remediation reactor unit 10 also includes means for defining a non-linear process fluid flow path within at least a portion of the interior chamber 18 defined in the reactor housing 12. The water treatment/remediation reactor unit 10 also includes a plurality of electrodes 20, 20 that are operatively positioned in the interior chamber 18 in fixed position therein. Where desired or required, the plurality of electrodes can be configured as an electrode array 22.

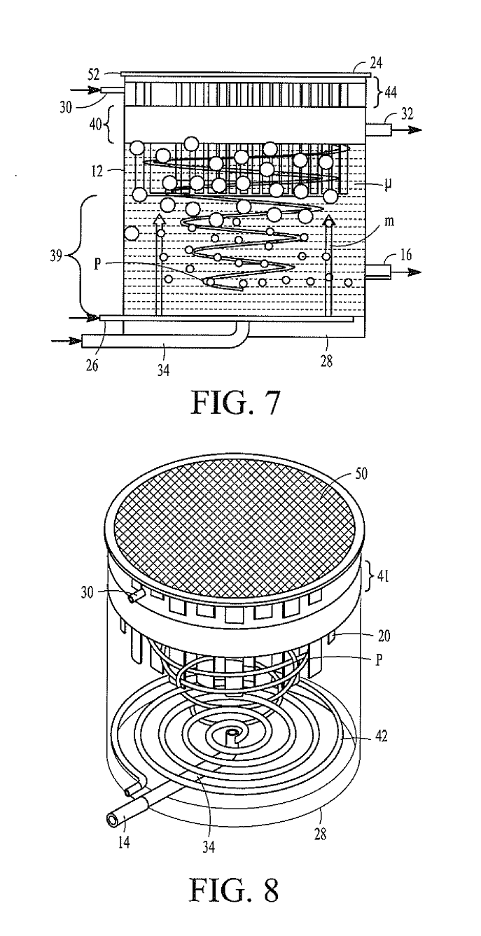

Electrode array 22 is oriented relative to the process fluid flow path P such that process fluid introduced in to the water treatment/remediation reactor unit 10 contacts and passes by the various electrodes 20, 20′. In certain embodiments, at least a portion of the electrodes 20, 20′ in the electrode array 22 are oriented relative to one another in a manner that produces a spiral configuration in the interior chamber 18 of the reactor housing 12. The spiral configuration can have multiple spaced helical wraps. In the embodiment depicted, the defined spiral can have between 3 and 8 wraps with 4 or 5 being contemplated in certain embodiments. The electrodes 20,20′ can be positioned in spaced relationship to one another at a distance and location that can facilitate fluid flow in a spiral direction for example in a in process fluid flow path P as illustrated in FIGS. 7 and 8. In the embodiment depicted, electrodes 20, 20′ are positioned in offset opposed relationship to one another and project downwardly from an upper face or top plate 24 of reactor housing 12 to terminate a location distal to the top plate 24 and at a region in the interior chamber 18 that is generally central thereto.

The water treatment/remediation reactor unit 10 as defined herein can be in operative communication with a suitable power source. The power source can include external electrical power supplied from municipal sources. It can include battery and fuels cells solar panels and the like. The water treatment/remediation reactor unit 10 can also include suitable controllers, switches, sensors and the like to permit the electrode to function at power range between 20 amps and 350 amps and between 2 volts and 60 volts. Where desired or required, the operating power can be varied within this range. In certain embodiments, it is contemplated that the power range will be between 40 amps and 250 amps and between 4 volts and 40 volts will be employed.

It is also contemplated that the water treatment/remediation reactor unit 10 can also include suitable switching, wiring and the like to permit establishment and/or reversal of polarity in the electrodes 20, 20′.

The water treatment/remediation reactor unit 10 also includes a reactive gas inlet 26 that is defined in the reactor housing 12 and configured to convey a quantity of a suitable reactive gas from an exterior source (not shown) into the interior chamber 18. The reactive gas is introduced into the interior chamber 18 at a location that permits the introduced reactive gas to comingle with the introduced fluid process stream. In the embodiment depicted, the reactive gas is introduced at a location proximate to the base 28 of the reactor housing 12.

The reactor housing 12 is also configured with a suitable reactive gas outlet 30 that is located at a position distant to the reactive gas inlet 26. In the embodiment depicted in the various drawing figures, the reactive gas outlet 30 is located proximate to the top plate 24. The reactive gas outlet 30 is configured to convey excess reactive gas and any associated spent gas material produced during processing to a located external to the water treatment/remediation reactor unit 10.

The water treatment/remediator reactor unit 10 can also include a suitable contaminant/oil outlet 32 located in the reactor housing 12 at a location generally coplanar to the electrodes 20, 20′ and above the treated water outlet 16 when the water treatment/remediation reactor unit 10 is in the use position.

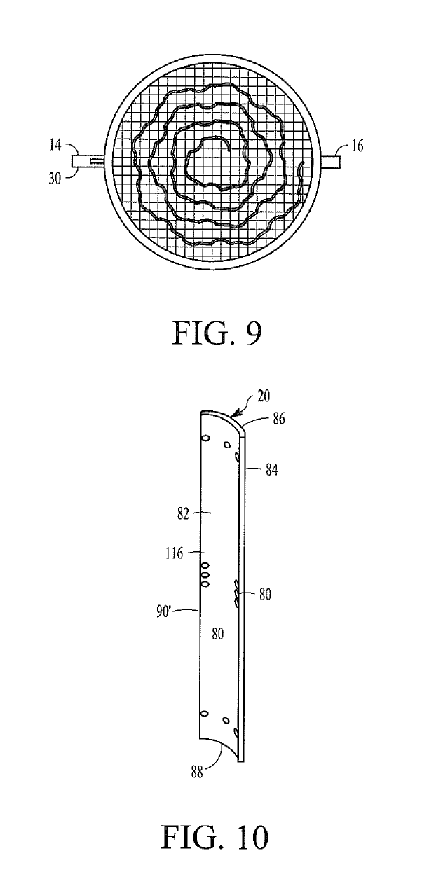

In the embodiment depicted, the electrode array 22 includes a plurality of electrodes 20, 20′ that are configured in alternating parallel relationship as illustrated in FIG. 3A such that the process fluid stream P is conveyed though the electrode array 22 from an entry point spirally to an exit point. In addition to the spiral conveyance, turbulence can be induced in the process stream P as it passes through the defined spiral pathway S by suitable means in order to assure intimate contact between the water, entrained contaminants and the reactive surfaces of the electrodes 20 20′. This can include, but is not limited to, the entrainment of at least a portion of the introduced reactive gas in the process stream. In the embodiment as illustrated, it is believed that placement of the electrodes 20, 20′can also be employed to induce a generally sinusoidal flow path in the process as it transits the spiral pathway S. A non-limiting example of a sinusoidal flow path is illustrated in FIG. 17. One non-limiting example of a suitable configuration of electrodes 20, 20′ is depicted in FIGS. 7 through 10 and will be discussed in greater detail subsequently.

The process fluid inlet assembly 14 can communicate with a suitable flow directing device in order to direct process fluid flow into initial contact with the electrode array 22 at a desired location for further processing within the water treatment/remediation reactor unit 10. In the water treatment/remediation reactor unit 10 as illustrated in various drawing figures, process flow directing device 34 includes the curved region 19 in fluid communication with the process fluid inlet assembly 14 such that the process fluid inlet assembly extends along a base 28 defined in the reactor housing 12 to a central location within the interior chamber 18 defined in the housing and proximate to the base 28. In the embodiment depicted, the reactor housing 12 defines a generally tubular interior chamber 18 and with the outlet 36 of the process flow directing device 34 being located proximate to the radial center of the base 28. While the process fluid inlet assembly 14 and process flow directing device 34 can be separate elements, it is also contemplated that the inlet assembly 14 and the process flow directing device 34 can be a unitary member in certain embodiments.

The process water to be treated or remediated can be introduced into the reactor housing 12 in a manner sufficient to deliver at least a portion of the introduced water to location centrally located relative to the electrode array 22. a radially central location in the electrode array 22 such as entry region 38 which is also configured as the interior origin I of the spiral S. One such configuration is depicted in FIG. 3A. At least a portion of the introduced fluid process stream P is directed to a region proximate to the upper region of the interior chambers where it is directed into the spiral pathway defined by the plurality of electrodes 20, 20′ in the electrode array 22 where contaminants are brought into intimate contact with the reactive surfaces of the electrodes 20, 20′ where one or more contaminants present in the introduced process stream are reacted electrochemically with one another, with the water molecules in which the contaminates are entrained, and/or with reactive gas that is introduced into the interior chamber 18. The reactions that occur produce molecules that are amenable to coagulation and removal from the process stream.

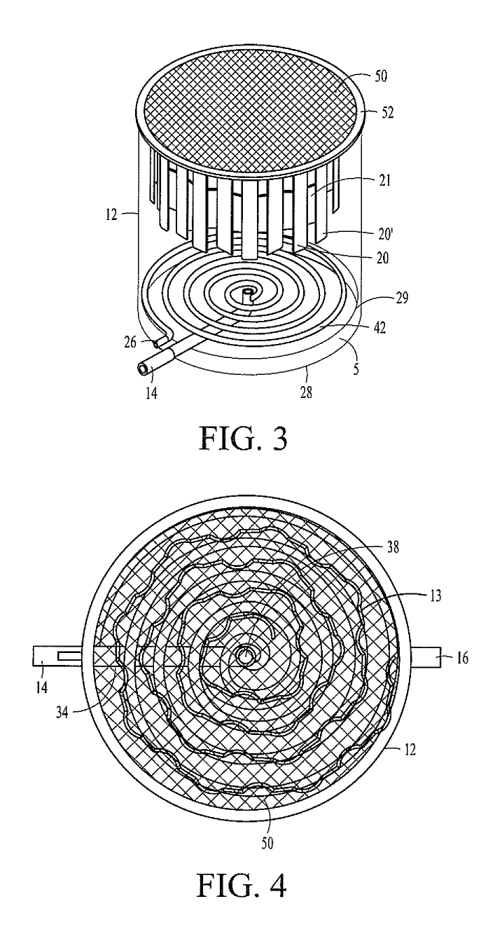

It is also within the purview of this disclosure that the process stream can be introduced into contact with the electrode array 22 at the outer portion of the spiral S and can be directed to the outer region of the spiral S by suitable means including ancillary flow directing mechanisms (not shown). In this introduction modality, it is contemplated that the introduced process stream and progress in a generally upwardly oriented outwardly progressing spiral such as the configuration depicted FIG. 4 for introduction into the electrode array 22 at an outwardly oriented position such that the material progresses through the electrode array 22 to an interior termination point at which point the process stream can be directed downward for removal though a suitable located treated water outlet 16.

Once molecules of water and any contaminants present the process stream have completed contacted the plurality of electrodes 20, 20′, the process stream is directed downward in the interior chamber 18 toward the treated water outlet 16 where it can be conveyed for further treatment, discharge or collection as desired. As the process stream is directed downward, the reacted contaminants are rendered buoyant and rise relative to the introduced process fluid into a contaminant collection zone 40 that is located generally in the interior chamber 18 in the upper quarter to third of the water treatment/remediation reactor unit 10. The contaminant/oil outlet 32 is located is generally located in the reactor housing 12 coplanar and in fluid communication with the contaminant collection zone 40 such that the reacted buoyant contaminants are conveyed out of the water treatment/remediation reactor unit 10 for disposal, further processing or the like. The removed contaminants may be present in any suitable form. In certain applications, it is contemplated that at least a portion of the reacted contaminant may be present in concentrated form in an aqueous stream that can be dewatered in one or more post-reactor processes.

In certain embodiments, the contaminant reaction process can proceed in the presence of suitable reaction gas that can be introduced in to the water treatment/remediation reactor unit 10 by suitable means. The reaction gas can be any suitable material that supports and/or promotes the reaction and removal of contaminants before during or after contact with electrodes present in the electrode array. It is contemplated that the reactive gas can be introduced as a pure material or in admixture with one or more gasses. In certain embodiments, the reaction gas will be composed of hydrogen and/or oxygen, either in pure form or in reactive admixture with other carrier gasses. It is also considered to be within the purview of this disclosure that the introduced gas be composed in whole or in part of inert, non-reactive or partially reactive materials and that the specific component make-up of the introduce gas can be varied depending on the nature and/or origin of the contaminants in the process stream and/or the gaseous material available for use.

The gaseous material can be introduced in to the interior chamber 18 by any suitable means. Thus the water treatment/remediation reactor unit 10 can include suitable metering devices and the like (not shown) to regulate the introduction of gas into the interior chamber 18. In the embodiment illustrated in the disclosure, the reactive gas inlet 26 communicated with a suitable gas introduction conduit 42. The gas introduction conduit 42 will be located proximate to the lower region of the interior chamber 18 and will have a suitable configuration to introduce the gaseous material into contact with the process stream P as entrained gas as well as bubbles having an average diameter in a range that permits that introduced gas to rise in the interior chamber 18 without unduly altering process flow of the aqueous process fluid passing within the interior chamber 18. In certain embodiments, at least a portion of the bubbles will have an average diameter between 1 nanometer and 10 micrometers.

Where desired, the gas introduction conduit 42 can be configured to introduce reactive gas in a manner that generally blankets the lower region of the interior chamber 18. One non-limiting example of the gas introduction conduit 42 is depicted in FIGS. 14 through 16. The gas introduction conduit 42 as depicted in the various drawing figures includes at least one gas delivery member 44 that is composed of a material which is generally non-reactive to the gas material conveyed and to the various materials present or generated in the water treatment/remediation reactor unit 10. The gas delivery member(s) 44 can have a configuration suitable to convey that gaseous material from a suitable source into communication with the process stream P as it is present in and moves through the interior chamber 18. In the embodiment depicted the gas introduction conduit 42 can be a tube or other profile. The material of construction can be steel or other non-reactive material and will include one of more gas outlet perforations 46 that are located coplanar to one another in spaced relationship along the length of the gas delivery member. The gas outlet perforations may be of any size capable of introducing the reactive gas in to the process stream.

In the embodiment illustrated in the drawing figures, the gas introduction conduit 42 is configured as a spiral member with the perforations 46 are disposed along the length of the tubular member. The multiple perforations 46 can be positioned on the gas delivery member 44 in any orientation and suitable to deliver the gaseous material. In certain embodiments, the perforations 46 can be positions at equidistant locations from one another long the tube. It is also within the purview of the disclosure that perforations 46 be positioned in suitable discrete arcuate locations on the spiral gas delivery member 44.

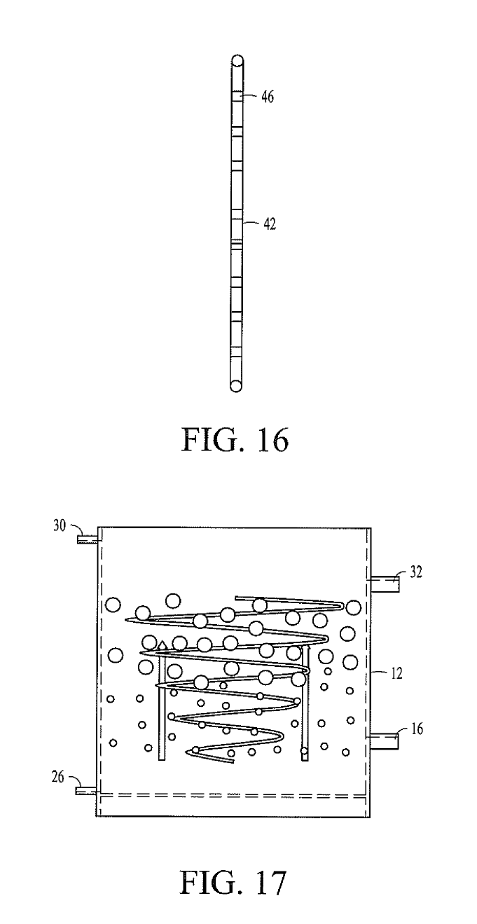

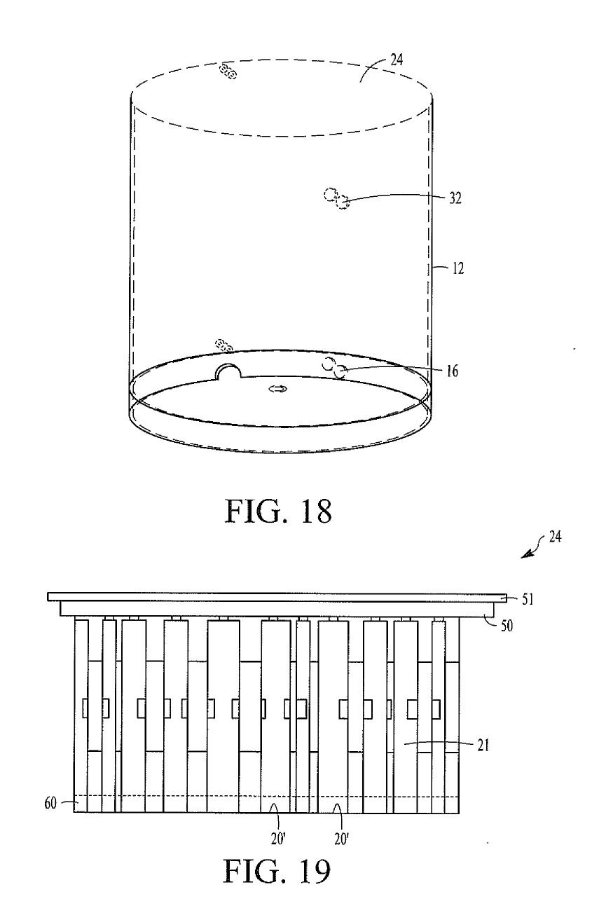

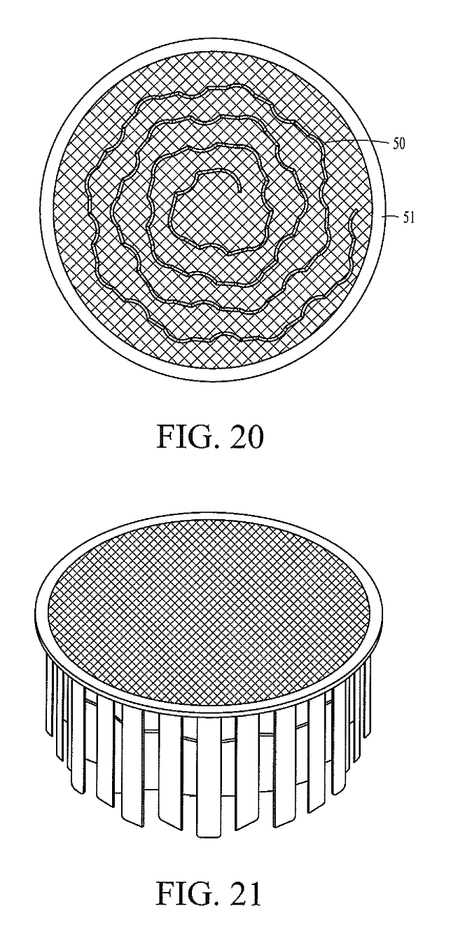

At least a portion of the perforations 46 can be oriented on the upwardly oriented surface 48 when the gas introduction conduit 42 is in the use position. It is also contemplated that additional perforations 46 can be positioned on other faces of the tubular member 44 such as the side faces as illustrated in FIG. 16 where desired or required.

The water treatment/remediation reactor unit 10 can also include a reactive gas outlet 30 that is configured to suitably remove introduced reactive gas as well as any gas generated during the water treatment process from the interior chamber 18 so as to prevent gas build up and/or to induce or promote introduction of additional gas material. The removed gas can be collected in suitable storage vessels (not shown) for use in related or unrelated processes and procedures. It is contemplated that the introduced gas can be a gas that provides or supports and oxidative environment in the interior chamber. Thus the introduced gas can be oxygen or an oxygen containing mixture of gases. It is also contemplated that the reactive process progressing in the interior chamber 18 can be one which produces and/or liberates hydrogen which can either be collected for use in energy generating devices such as fuel cells or can be disposed of in an environmentally suitable manner.

The water treatment/remediation reactor unit 10 can also include a suitable lower screen 29 on which the gas introduction conduit 42 can be supported. It is contemplated that the lower screen 29 can be made of a suitable non-reactive material and can be located a spaced distance from the base 28 of the reactor housing 12. The spaced distance between the base 28 and the screen 29 can define a settlement region into which any sediment generated during the treatment process can collect. It is contemplated that the settlement region S can be accesses by a suitable port or the like to facilitate periodic removal of collected sediment.

The electrodes 20, 20′ can be elongated members 80 and can be composed of any suitable electroconductive and/or electrolytically reactive material. In certain embodiments, the electrodes can be constructed of carbon, graphite or any number of metals such as iron, titanium, platinum, zinc, aluminum, ruthenium and the like, whether solid or plated, or combinations of materials depending on the desired treatment or application. It is contemplated that the electroactive material can be mounted on suitable support surfaces if desired or required. Where carbon is employed as an electrode material, the carbon can be of a suitable electrode grade; for example, grade 1940 carbon. Where a metal is employed, the material of choice will be a suitable commercially pure grade metal such as commercially pure grade 2 titanium.

The electrodes 20, 20′ can each have an upper edge 86, a lower edge 88 opposed to the upper edge and opposed side edges 90, 90′. Each electrode 20, 20′ can include a first face 82 and an opposed second face. 84.

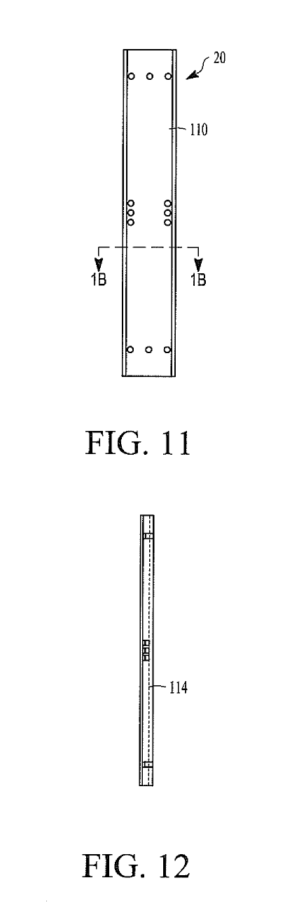

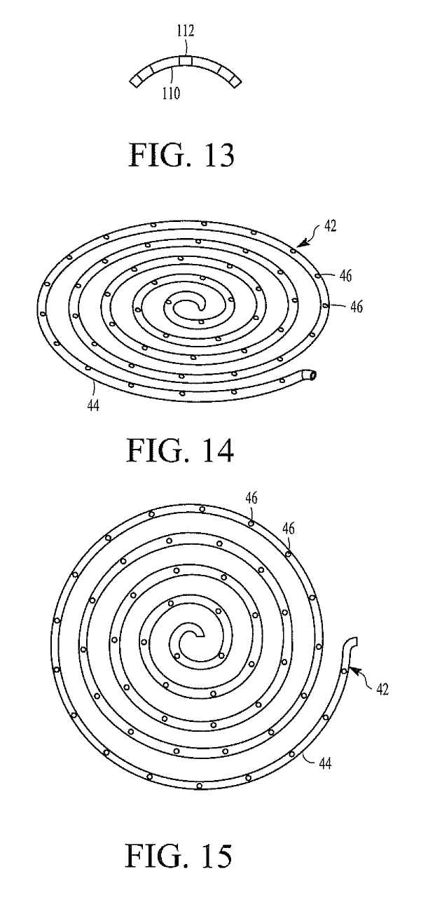

In certain embodiments, the electrodes 20, 20′ can have a length suitable to extend downward from the region proximate to the top 24 of the housing 12 to a location approximately in the intermediate region 39 of the interior chamber 18. In certain embodiments, the electrodes can have a length between 2 and 30 inches. The electrodes 20, 20′ can be flat elements as illustrated in FIG. 3B. In certain embodiments the electrodes 20, 20′ can be each configured with an elongated longitudinal curved central region as in FIGS. 4, and 11 through 13. It is contemplated that the electrodes may have a cross sectional curvature between 60 and 100 degrees in certain embodiments.

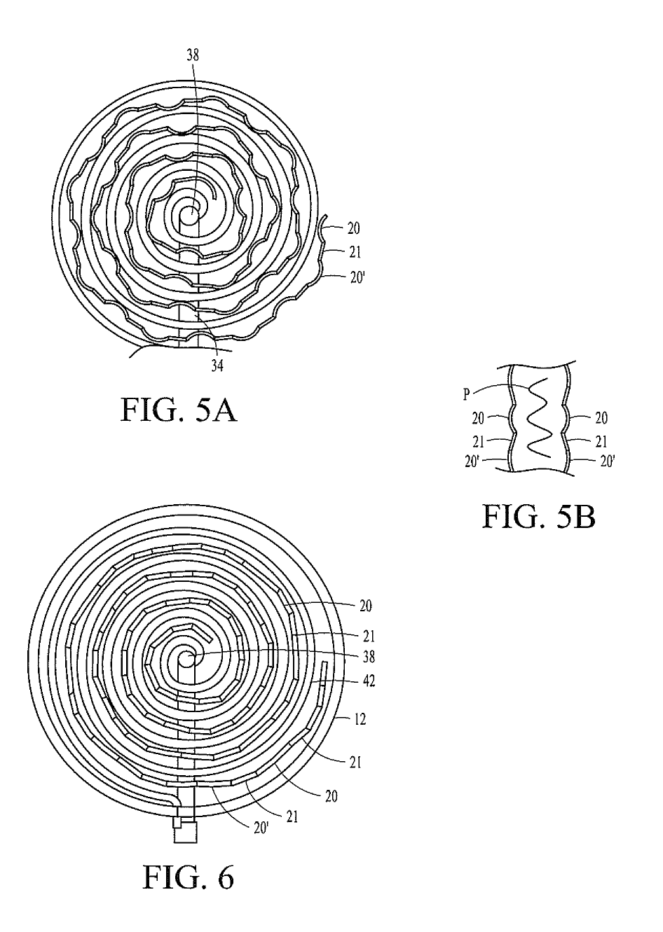

The electrode array 22 can have a plurality of curved electrodes 20,20′ arranged in alternating curved orientation relative to one another and configured in a spiral relationship as illustrated in FIGS. 4 and 5. It is contemplated that the electrode array 22 can be configured with between 2 and 10 spirals. In certain embodiments, the electrode array 22 will have between 3 and 7 spirals. In the embodiment depicted the electrode array 22 has 4 spirals.

The electrode array 22 will be anchored to the upper portion of the reactor housing 12 in a manner that orients the electrodes 20, 20′ in spaced relationship such that the mating spiral defined in the gas introduction conduit 42 is positioned in interposed relation to the electrode spirals. The electrode array 22 can also include suitable spacers 21 that are interposed between the respective electrodes 20 20′and connected to at least a portion of respective sides regions 90, 90′ of each associated electrode 20, 20′. It is contemplated that the spacers 21 can be made of a suitable non-conductive material. The electrode array 22 can also include a screen 50 that is positioned proximate to the upper edges 86 of the respective electrodes 20, 20′ in the electrode array 22. That electrodes 20, 20′ are connected to a suitable power source that can deliver electrical power to the individual electrodes 20, 20′. Non-limiting examples of power delivery devices include bolts and the like. It is also contemplated that positive or negative energy will be delivered to specific electrodes 20, 20′ In certain embodiments, it is contemplated that the individual electrode 20, 20′ will alternate in a pattern of cathode, anode, cathode, anode along the spiral configuration. It is also contemplated that the device can be configured to reverse polarity across some or all of the electrodes where desired or required. Thus the water treatment/remediation reactor 10 as described herein can include suitable switches and controls to reverse polarity across on or more electrodes 20, 20′.

In certain embodiments, it is contemplated that a positive electrode will be positioned opposite a negative electrode 20′ with the fluid flow path P interposed there between as in the manner depicted in FIG. 5A. Other embodiments, it is contemplated that negative electrodes 20′ will be positioned opposed to one another and positive electrodes will be positioned opposed one another with the flow path interposed there between. One non-limiting example of this orientation is depicted in FIG. 5B. It is also contemplated that the electrode array 22 can have different orientations of electrodes at different locations on the spiral configuration. In applications where curved electrodes 20,20′ are employed in at least a portion of the electrode array 22, the convex regions of a least a portion of the electrodes 20, 20′ can be oriented in opposed relationship to one another. Without being bound to any theory, it is believed that opposed curve orientation can induce increased turbulence in the process water stream P as represented in FIG. 5B.

In operation, the process stream P made up of contaminated water enters the reactor housing 12 through the process fluid inlet assembly 14 by any suitable means as by pumping or the like. The contaminate laden process stream water is rises though intermediate region 29 defined in the interior chamber 18 between the water inlet and the lower edge of the electrode array 22 into contact with the electrodes 20, 20′ that are present in the electrode array 22. The water that makes up the process stream is introduced with sufficient velocity and force to convey the process stream P through spiral electrode array 22 at a speed that facilitates contact between the operating electrodes and the process water sufficient to promote electrochemical reaction between at least a portion of the contaminants present in the process stream to produce more benign and simplified products of the reaction. It is believed that some of the reaction products will be simple carbon products as well as reactive metal components.

Simultaneous with the introduction of the process stream, a stream of reactive gas material can be introduced into contact with the process steam P in the form of entrained gas and bubbles in the nanometer to micrometer scale. Reactive gas introduction is made n manner that permits the nanobubbles M to rise through process stream water in the intermediate region 39 into the region defined by the electrodes 20, 20′ in the electrode array 22. The nano/microbubbles can provide floatation and flocculation of various amenable contaminants present in process stream P while transiting the intermediate region 39. The nano/microbubbles can facilitate various electrode catalyzed reactions and can continue to provide floatation and flocculation of various reacted and unreacted contaminant material as the nano/microbubbles travel into a contaminate collection zone 40 that is proximate to the top of the reactor housing 12. The contaminant collection zone 40 is in fluid communication with a contaminant/oil outlet 32 where the reacted and isolated contaminant material can, in turn, be conveyed to suitable reservoirs for removal and/or post treatment processing . . .

It is contemplated that, in certain embodiments, the nano/microbubbles can provide a counter current flow to process water P as it exits the electrode array 22 and is conveyed to the treated process water outlet 16 that is in fluid communication with the intermediate region 39. As the treated process water exits through the treated water outlet 16 and the reacted and or isolated processed contaminant material exists the interior chamber 18 through the contaminant/oil outlet 32 in fluid communication with the contaminant collection zone 40, excess gas can be collected in a headspace region 41 through screen 50 and can be conveyed away from the water treatment/remediation reactor unit 10 through reactive gas outlet 30 where it can be collected, recycled and/or used in other downstream processes.

In order to further facilitate the separation of contaminants and/or maintain the integrity of the electrode array 22, water treatment/remediation reactor unit 10 can also include one or more separation membranes such as membrane 60 located proximate to the lower region of the electrode array 22.

The water treatment/remediation reactor unit 10 also includes suitable means for powering the various electrodes 20, 20′ (not shown). The power means can include means for regulating the operation and functioning of the electrode either individually and/or collectively including means for reversing the polarity of the electrodes when desired. Without being bound to any theory, it is contemplated that the reversal of electrode polarity either alone or in combination with the action of the of the nano/microbubbles can function with remove deposits that can accumulates on electrode surfaces as a result of the contaminant removal operations.

It is contemplated that the water remediation device as disclosed herein can be incorporated into a water treatment unit 100 an embodiment of which is illustrated in FIGS. 22 and 23. The water treatment unit 100 broadly includes one or more water treatment/remediation reactors 10 that are positioned and configured to be brought into fluid contact with a suitable process stream or water source. In the embodiment Illustrated in FIGS. 22 and 23, the water treatment unit 100 includes at least two elevated throughput reaction chambers assemblies 10. In certain embodiments, it is contemplated that each reaction chamber assembly 10 can have a capacity between 1 and 50 gpm; with capacities between 2 and 10 gpm being contemplated in certain applications. The reactions chamber assemblies 10 will include on or more of the electrode systems as described herein.

Water treatment unit 100 is designed to control the remediation process, ie the advanced linear electro-floatation process occurring in one or more of the reaction chamber assemblies 10 by allowing the user to control three treatment variables; the retention time or the flow rate of the process water to be treated, the current intensity (amps/cm2), and the selection of sacrificial and non-sacrificial electrodes. Two or more separately controlled reaction chambers, operating in parallel, are included in this water treatment unit 100. The reaction chamber assemblies 10 are easily accessible to allow the user to vary the anode and cathode material selection. In addition, the reaction chamber assemblies 10 can be disassembled and reassembled to modify the electrode configuration in each reaction chamber assemblies. The water treatment unit 100 can be configured with sufficient number of reaction chamber assemblies 10 to provide suitable treatment throughput. In the embodiment depicted in FIGS. 22 and 23, the reaction chamber assemblies 10 of water treatment unit 100 are configured to run in parallel. It is also within the purview of this disclosure to have one or more reaction chamber assemblies 10 configured to operate in series in order to target different chemical contaminants, etc.

The water treatment unit 100 is configured with a suitable process water intake 113 configured to connect to a process water source. Process water can be conveyed from the process water intake 113 through intake pipes 115 that are in fluid communication with the respective reaction chamber assembly 112.

It is contemplated the water treatment unit 100 can be configured with suitable pump(s) to maintain and augment process water flow through reaction chamber assemblies 112. In the embodiment as depicted, in FIGS. 22 and 23, the water treatment unit 100 is designed with two centrifugal pumps 114 each associated with a reaction chamber assembly 112 to provide fluid flow through the system. The centrifugal pump(s) 114 are in fluid communication with the respective intake pipes 115.

System operation is accomplished by using a consolidated control panel 516 that is in electronic communication with associated system components. The control panel 516 allows the operator to control and adjust key system variables quickly and with ease. System controls can be operated manually, automatically or a combination of the two depending on the configuration of the specific unit and/or the specific requirements of the user. It is also contemplated that the water treatment unit 500 can be configured to permit remote monitoring and operation of the unit or units. It is also contemplated that the water treatment unit can be configured such that adjustments can be made manually in real time, if desired, though a suitable user interface (not shown) or through direct manual operation on one or more manual adjustment mechanisms resident on the unit.

The water treatment unit 100 is can be configured and mounted on a skid or other suitable base 118 as desired or required by the specific characteristics environment and application. it is also contemplated that the water treatment unit 100 can be mounted in the interior of a shipping container or other trailer unit (not shown). In the embodiment depicted, elements such as the intake pipes 115, and reaction chamber assemblies 112 can be placed in fixed attachment to a suitable structural element of the skid or base 118. It is contemplated that the water treatment unit 100 so configured can be brought to a location close to the process stream or other body of water that is to be treated. It can be appreciated that the water treatment unit 100 as disclosed herein can be used in a variety of industries including, but not limited to, oil and gas, agriculture, industrial waste streams, and many others.

Where desired or required, the reaction chamber assemblies 10, can be configured with electrodes as previously described. In certain embodiments, the electrodes can be configured to be self-cleaned and/or cleaned in place. It is contemplated that the cleaning process can be accomplished by rotational action of the respective electrodes as was previously described. It can also be facilitated by the action of the water turbulence itself as it progresses in spiral fashion through the reaction chamber assembly 10.

Thus it is contemplated that the reaction chamber assembly 10 can include one or more turbulence inducing devices located at or near the process fluid inlet to the reaction chamber assembly 10. Where desired or required, the turbulence inducing devices can cooperate with the location of the process fluid inlet to produce an upwardly oriented spiral path around the electrodes housed inside the reaction chamber assembly 512 for at least a portion of its residence time in the reaction chamber assembly 10. The turbulence inducing device may be configured with internal conduits in the manner described previously to produce the desired internal fluid flow patterns.

In the embodiment depicted in FIGS. 22 and 23, reaction chambers 10 are in fluid connection with a suitable outlet conduit 120. In certain embodiments, outlet conduit 120 can exit directly from the water treatment unit 500. In the embodiment depicted, the outlet conduit 120 can convey water from the reaction chamber assemblies 10 to suitable post treatment elements. Non-limiting examples of such post treatment elements include settling tank 122 and separator 124. In the embodiment depicted, the process stream exits the final post treatment element such as separator 124 and/or settling tank 122 into process stream outlet conduit 126 where it is conveyed to treated process stream outlet 128. Inlet 113 and process stream outlet 128 can be configured to connect to suitable external conduits and the like to permit the material to be conveyed to and from the water treatment unit 100. Where the water treatment unit 100 is configured in a transit container, it is contemplated that inlet 113 and process stream outlet 128 can extend through the associated container wall. In certain applications the through the wall junction will be one that is proximate to the base or floor of the associated container.

Wherein desired or required, the reaction chamber assembly 10 can include circular electrodes that are disposed in the reaction chamber assembly 10 in the manner described previously. The system can be operated manually or can be configured to respond to remote electronic commands. The electrodes can receive negative and positive current and deliver the current to the respective electrodes in the manner described previously. The water treatment unit 100 will include suitable means for delivering appropriate electrical supply to the electrodes for maintaining the advanced linear electro-floatation process as well as powering any pumps, and ancillary devices. Such electrical delivery means includes various wires, cables and the like. The source of electric power can be an external source. Alternately, the source of electrical power can be one or more batteries 130 in the form of a battery array 132.

The battery array can be configured to be rechargeable by a variety of methods including but not limited to connection with an externally maintained power source, connection to on board solar cells (not shown) and hydrogenation from by-products of the linear electro-floatation process occurring in the water treatment unit 500. Where hydrogenation is employed, at least a portion of the hydrogen generated from the water treatment process can be conveyed through the flue member 134 exiting reaction chamber assembly 10 to a suitable hydrogen cell or the like.

The water treatment/remediation unit 10 as disclosed herein can be employed to accomplish water treatment and/or remediation as a stand-alone unit, as part of a device such as the water treatment unit as described herein. The water treatment/remediation unit 10 as disclosed herein can also be employed as a subcomponent in various other process systems. It is also contemplated that the water treatment/remediation unit 10 as disclosed herein can be employed to implement a method for remediating and/or pretreating aqueous process streams; particularly those that present particular challenges. Non-limiting examples of particularly challenging treatment and remediation processes include process streams containing heavy metals, process streams having high brine contents, process streams containing organic loading for example halogenated organics, organic emulsified material high molecular weight organic material and the like process streams containing suspended and dissolved solids of various origins, and process streams having loads of biological derived contaminants including but not limited to fecal matter, microorganisms and the like. It is also understood that the process stream to be treated or remediated can include various combinations of the foregoing

It has been found, quite unexpectedly that the process disclosed herein utilizes and addresses specific characteristics and challenges found and presented by aquaculturing operations; particularly those occurring in salt water environments. It has long been recognized that the present of the elevated levels of chlorine compounds in salt water present enhanced problems during water remediation process. These can include the generation and removal of hydrogen, chlorine and the like.

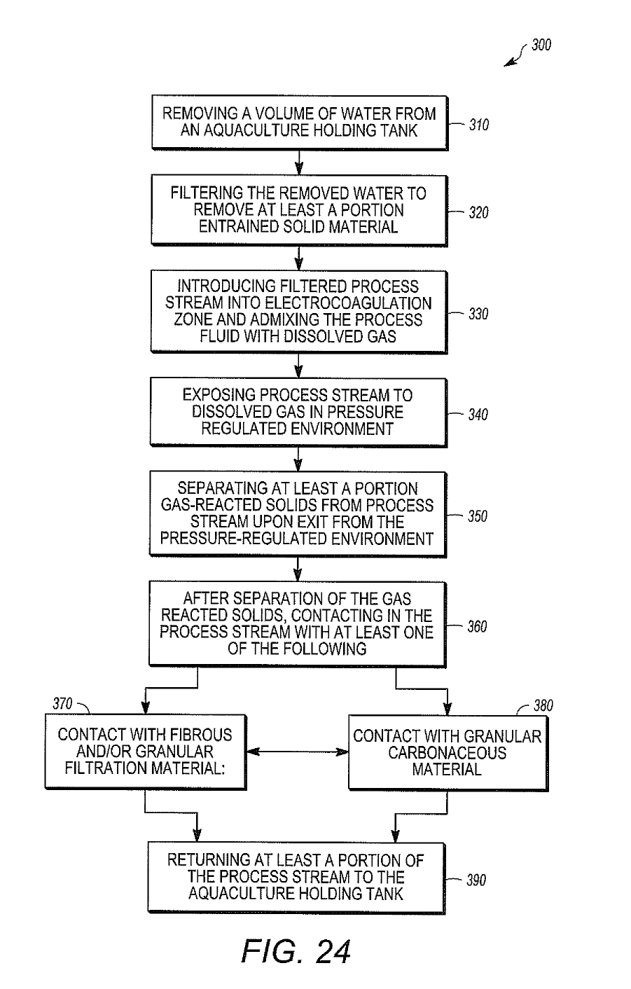

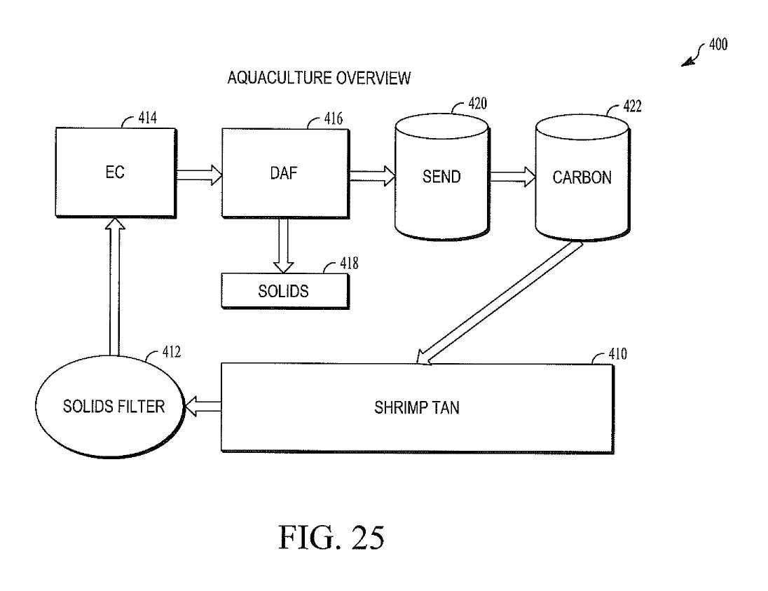

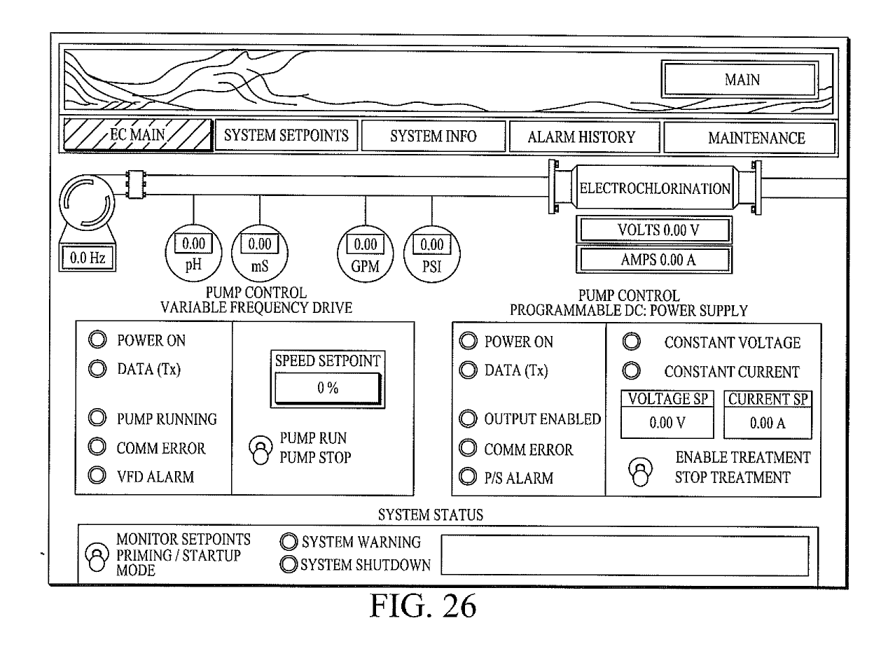

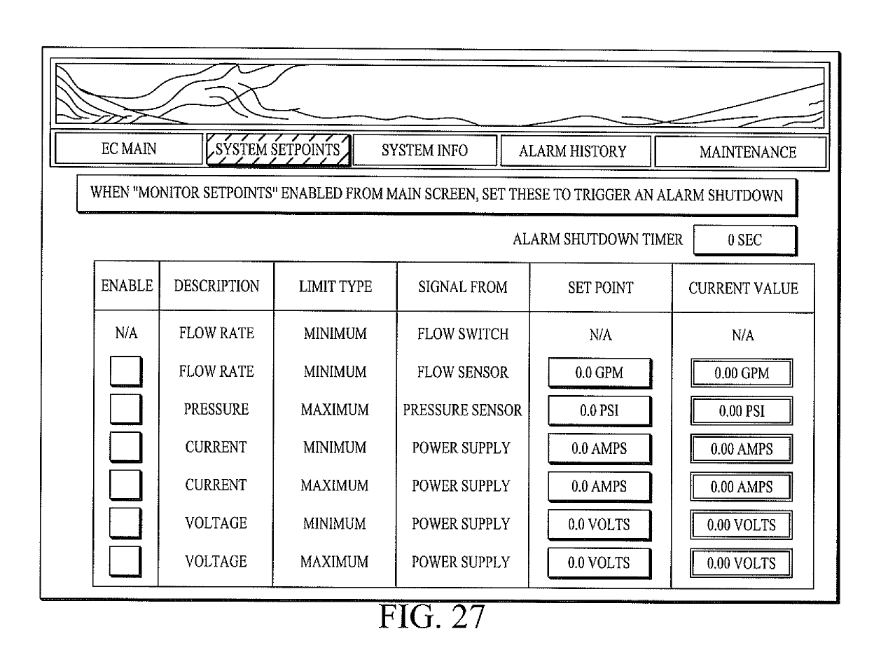

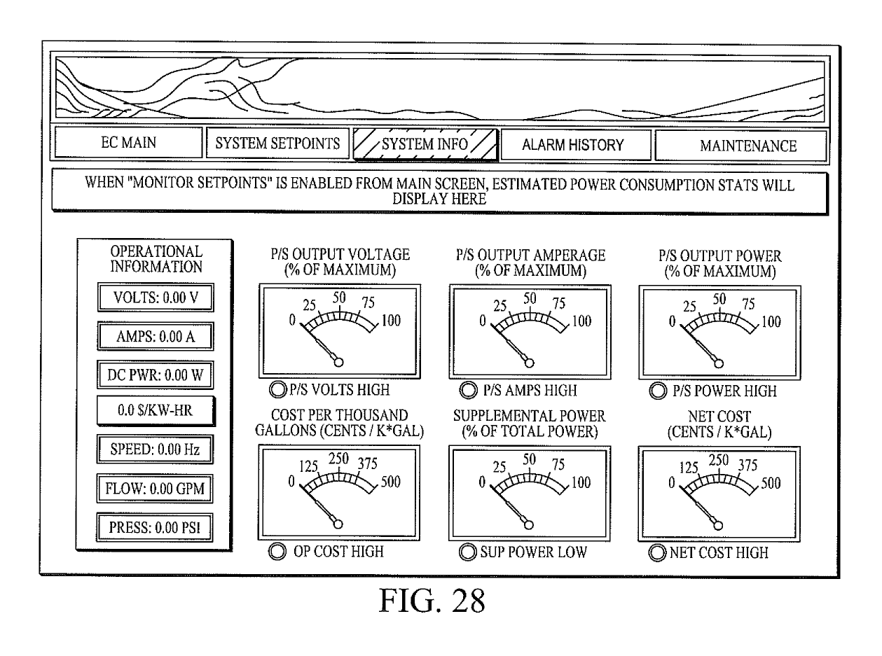

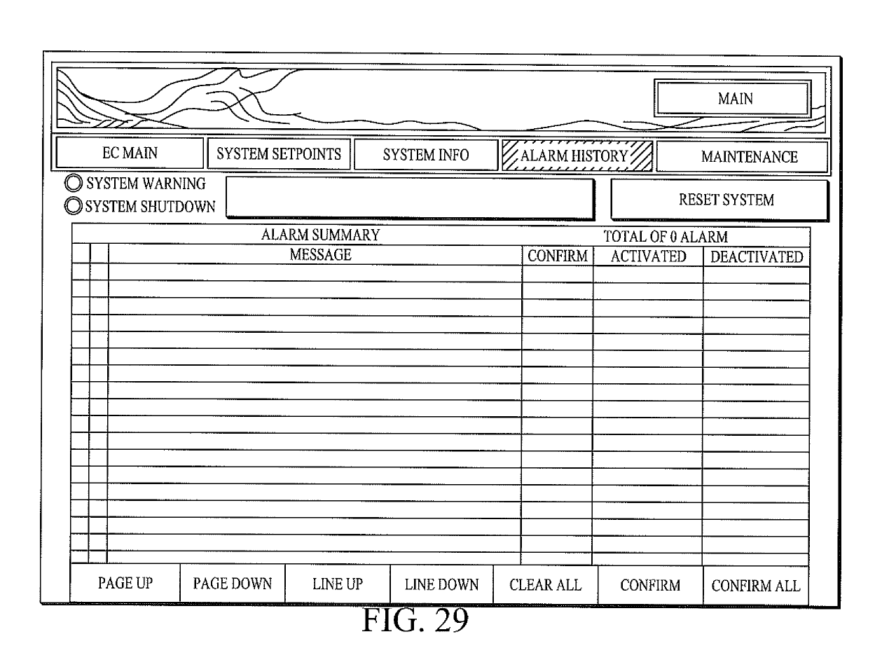

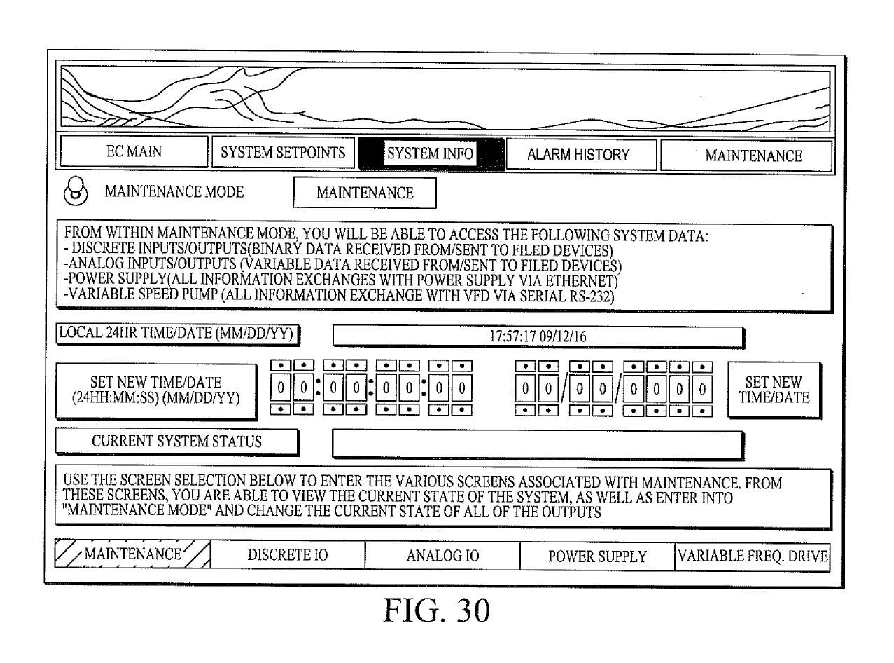

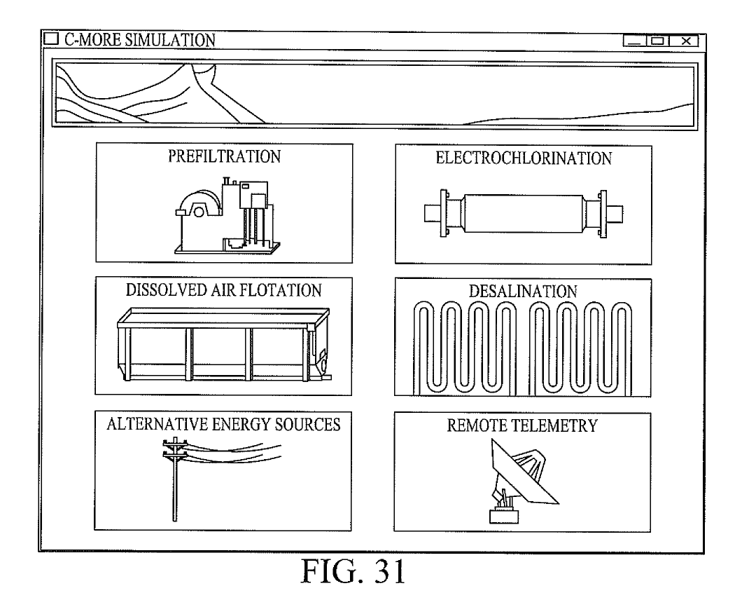

An embodiment of the method/process 300 as disclosed herein is outlined in the FIG. 24 together with a schematic overview of one non-limiting example of a schematic process 300 diagram in FIG. 25. The process 300 is directed to a process in which high salinated water such as brine water containing a high load of biologically derived material such as fecal matter, biologically decomposing animal parts, microorganisms, including various microorganisims can be remediated in an electrofloatation process as disclosed herein.

The term “electrofloatation” as employed herein, is defined as the process by which water containing at least one target contaminant is exposed to electroactive charged material resident on electrodes which in their charged state induces an advanced linear electro floatation event (ALEF) that incorporates processes associated with electrocoagulation/electro-floatation induced by the passing of electrical current through water and various elemental electrode catalysts to effect the isolation and removal of target contaminants from the aqueous process stream.

Without being bound to any theory, it is believed that the process stream that is introduced into the water treatment remediation reactor unit 10 as disclosed herein are exposed to strong electric fields, currents and electrically induced oxidation and reduction reactions. Depending on the solution matrix, exposure of the process stream to the reactive environment in the water treatment/remediation reactor unit 10 for an interval between 0.5 seconds and one hour or more depending on factors such as the nature and concentration of the chemical contaminant will result in the ultimate elimination of target contaminant from the process stream. Non-limiting examples of target contaminant include heavy metals, large and small molecule organic materials and compounds, biologically derived contaminants and the like.

As used herein the term “heavy metals” is defined as metals and metalloids with relatively high densities, atomic weights, and/or atomic numbers. Non-limiting examples of such heavy metals include iron, copper, tin silver, gold, platinum, magnesium, aluminum, titanium, gallium, thallium, hafnium, indium, ruthenium, cadmium, mercury, lead, zinc, beryllium, scandium, chromium, nickel, cobalt, molybdenum, arsenic, bismuth, selenium, germanium, indium, iridium, as well as compounds and complexes containing one or more of the foregoing. Such materials can be found in a variety of effluent streams including those produced by manufacturing industries, chemical industries and the like. It can be appreciated that a number of the forgoing are identified as toxic pollutants by governmental agencies, for example, the US Environmental Protection Agency. Metal contaminants so listed include materials and compounds containing compounds such as arsenic, beryllium, copper, cyanides, lead, nickel, selenium, silver, thallium, zinc. It is contemplated that the device and process disclosed herein can accomplish the removal of over 99 percent of heavy metals from the associated process stream.

“Large and small organic molecular contamination”, as defined herein include but are not limited to materials classified as toxic by regulatory agencies such as the U.S. EPA. Non-limiting examples of such compounds are benzene and its derivatives, carbon tetrachloride, chlordane, chlorinated dichlorinated and polychlorinated hydrocarbons such as ethanes, ethers and alkyl ethers, chlorinated, dichlorinated, and polychlorinated materials such as naphthalene, chlorinated phenols, chloroform, ethyl benzene, haloethers, halomethanes, hexachlorinated dienes, naphthalene, isophorone, nitrophenols, nitrosamines, PBBs and PCBs polynuclear aromatic hydrocarbons, tetrachloroethylene, toluene, trichloroethylene, and vinyl chloride. It is contemplated that the device and process as disclosed herein can reduce one or more of the large and small molecular contaminants to levels below 1% and, in some instances, to levels below detection limits.

It is to be understood that various embodiments of the device as disclosed herein can be efficaciously employed to treat process effluent arising from a variety of sources. For example, effluent material produced in chroming operations can contain materials such as acid soluble copper, nickel, chrome, and cyanide. It has been found, quite unexpectedly that the method and device as disclosed herein can be employed effectively to reduce or eliminate such compounds. Other compounds that can be removed or reduced using the method and device as disclosed herein include but are not limited to total suspended solids, and various biological compounds.

It is also contemplated that the advanced linear electro-floatation method as disclosed herein produces an environment that is able to disrupt the cell wall or cell membrane of certain microorganisms present in the process water thereby reducing the bacterial load of the treated process water.

Without being bound to any theory, it is believed that the process and system disclosed herein also uses a combination of natural forces including, but not limited to: electrocoagulation (EC)/electro-floatation (EF), magnetism, vortex-induced vibration, frequency resonance, advanced fluid dynamics and certain aspects of scalar energy to achieve the most efficient and thorough treatment possible.

As an example of one such electrofloation process and method, a volume of water can be removed from an aquacultural holding tank as at reference numeral 310. Non-limiting examples of suitable holding tanks include breeding and feeding tanks as well as various intermediate tanks and vessels used in the breeding and raising of farm bred fish and crustaceans such as shrimp tank 410. It is also contemplated that the aquacultural operations can include the aqueous growth and processing of various vegetative materials such as kelp, sea cucumber, etc.

The shrimp tank 410 can be a unitary device or can be a collection of water carrying and/or conveying devices associated with the aquacultural activities be performed. The process water that is removed for remediation and treatment can be removed in either batch or continuous processes by any suitable mechanism. Thus the system 400 as disclosed herein can include suitable pumps, conduits and the like (not shown).

Where required, the process water removed from the aquaculture holding tank 310 can be collected as an aqueous process water and can be subjected to a process step to remove at least a portion of any entrained material that is present in the process stream as at process step reference numeral 320. It is contemplated that this step can be employed to remove visible solids and debris and can be accomplished by one or more of various separation process including centrifugation, settlement and the like. In many applications the initial separation process includes filtration processes such as gravity filtration and the like as by one or more solids filters 412. It is contemplated that the solids material that is removed from the process stream as can be can be processed and or disposed of in an environmentally suitable manner. In situations where the process water does not contain high concentrations of solids and debris, it is contemplated that one or more of the solids separation operations and steps can be by-passed.

The process stream can be directed to at least one electrofloatation/electrocoagulation device as at reference numeral 414. In specific embodiments, the electrofloatation device can be configured to remove at least one of refractory organic compounds, suspended solids, heavy metals and the like. It is contemplated that the process water can be exposed to one or more electrocoagulation events in one or more electrolytic cells contained in either one or more water treatment/remediation units in order to promoted one or more electrolytic reactions thus forming the electrofloatation/electrocoagulation zone as at process reference numeral 330. It is contemplated that several electrofloatation/electrocoagulation reactions can be produced independently or in combination with in the electrofloatation/electrocoagulation zone. It is also contemplated that the electrofloatation/electrocoagulation zone can be composed of one or more discrete water treatment/remediation units and that some of the water treatment/remediation units can be configured as tubular units with radially disposed cathodes and anodes is desired or required. In certain applications of the process and method as disclosed herein, it is contemplated that tubular units with radially disposed electrodes can be employed as a pretreating or post treatment polishing operation.

It is believed that the process water under treatment that is introduced into the water treatment/remediation reactor unit(s) may include metal ions including but not limited to various heavy metals. Within the at least one reactor units, it is believed that an anode reduction of the metal ions to form new centers for larger stable insoluble complexes that can precipitate as complex metal ions. Oil molecules that may be present in the process fluid can be rendered into water insoluble complexes and separated from the associated water though catalytic emulsion-breaking. It is believed that oxygen and hydrogen produced during electrolytic processes can bond into water receptor sites on various emulsified and emulsifiable molecules present in the process stream to create complexes that can be separated from the process stream as a result of the electrocoagulation or in subsequent operations. Where desired or required, the oxygen and/or hydrogen produced during the electrolytic process can be augmented with additional quantities of introduced gas, at least a portion of which can be present as dissolved gas within the process stream.

The electrolytic process and method as disclosed herein can be also be employed to treat pesticides, herbicides and various chlorinated compounds present in the process stream. It is believed that at least some of the metal ions either present as sacrificial material on the surface of one or more electrodes or liberated during the electrolytic process proceeding in the associated reaction chamber can bind themselves to halogenated hydrocarbon molecules to produce larger molecules that are insoluble or only partially insoluble in water. Oxygen ions produced in the electrolytic process in the reaction chamber can oxidize biohazards, bacteria, viruses etc. that are present in the process stream. The oxidation reduction reactions what occur proceed to natural end points and typically will yield material that has a generally neutral pH.

It is contemplated that the electrode material can be one or more of the following: iron, aluminum, titanium, graphite as well as other electrode materials. The current, process fluid flow rate initial solution pH, etc. can be modified based on initial process water conditions. It has been found, quite unexpectedly that the process as disclosed herein, when applied to remediation and treatment of aquaculture process water having elevated salinity such as brine water used in shrimp farming and the like can produce elevated levels of sodium hypochlorite and hydrogen. In aqueous environments, the hypochlorite will form hypochlorous acid which can be measured as free chlorine. The hydrogen that is generated can be employed in various points in the overall process disclosed herein. Portions of the generated hydrogen can also be collected and conveyed for use in other processes and procedures. It is contemplated that at least a portion of the hydrogen produced can be conveyed to suitable storage devices and fuel cells that can be employed to provide power for the electrodes in the electrolytic cell(s).

Shrimp and fish food processing produce fecal material contains nitrogen compounds. When nitrogen compounds are present in the aquaculture water, these nitrogen compounds present a bacteria rich environment that promotes a nitrate cycle in which nitrogen is present in equilibrium between ammonia, nitrites and nitrates. It has been found that elevated levels of one or more of these nitrogen compounds is detrimental to shrimp or fish production and culture. It is believed that the process as disclosed herein provides a method and apparatus that will permit and facilitate the conversion of nitrogen containing compounds into chloro-nitrogen compounds such as chloramines that can function bacteriostatically and as a bactericide in the in process stream; reducing the bacterial load in the process water as it undergoes treatment. It is believed that at least a portion of the chloramine compound is present as monochloramine. Thus the electrolytic process can function to reduce nitrogen load—particularly present as ammonia and nitrates with concomitant reduction on microbiological contamination.

Electrolysis can be accomplished by various electrolytic devices. One non-limiting example of a suitable device is that depicted in FIGS. 22 and 23. The electrolytic process can proceed without introduction of gaseous material. In the electrolytic device disclosed herein, gaseous material such as hydrogen can be introduced. It is contemplated that the hydrogen produced in the electrolytic process can be recycled and reused.

After the process water material has been treated in the water treatment/remediation reactor unit of the electrolytic device, the process water material can be exposed to a gaseous material in a manner sufficient to introduce dissolved gas in the process water. This exposure can occur in a pressure regulated environment as at reference numeral 340. The pressure regulated environment can be any suitable vessel capable of maintaining the process water and introduced at an elevated pressure sufficient to urge elevated concentrations of gaseous material into intimate contact with the process stream and any target contaminants contained therein.

In certain embodiments, the pressure vessel can be configured as a dissolved air floatation (DAF) vessel as at reference numeral 416. In certain embodiments, it is contemplated that the DAF 416 will be configured to permit release of dissolved gas is released after a specified interval allowing entrained material to float to the surface of the treated water where it can be removed by any suitable process such as skimming or the like as at reference numeral 350. The removed solids can be collected in in a suitable collection vessel as at reference numeral 418. The process water that is being treated can be dosed with a coagulant to further coagulate entrained and contained material to coagulate material into particles that can be removed from the process stream. The process water that is being treated can also be dosed with suitable flocculent to assist in the dissolved gas flocculation process. In certain embodiments, it is contemplated that the DAF will include suitable mechanisms to meter the introduction of the flocculants and or coagulants into the process stream as needed. It is also contemplated that coagulants and flocculants can be added to the process stream in intervals subsequent to exit from the DAF 416 with collection of the solids occurring as required and collected solids accumulated in a suitable collection vessel such as solids collection vessel 418. Non-limiting examples of suitable coagulants include materials such as ferric chloride or aluminum sulfate

Where desired or required, the process stream can be exposed to one or more post dissolved air flocculation filtration processes as at reference numeral 360. The post-DAF filtration process(es) can be employed to remove residual particulate material and/or to remove or reduce halogen-containing constituents prior to final discharge. In the process as depicted in FIG. 24, the process stream can be brought into contact with fibrous and/or granular material such as sand or the like as at reference numeral 370 that is held on one or more vessels as at reference numeral 420. The process stream can also be brought into contact with a suitable carbon material contained in a suitable vessel 180 that can be contained in one or more vessels 422. The carbon material and associated vessel can be configured to remove one or more halogen-containing compounds

Once the process stream material has been exposed to one or more of the filteration material vessels 320, 322 as a reference numeral 370 and 380, the process material can be conveyed away from the filter units. The process material can be discharged if desired or required. It is also contemplated that at least a portion of the process stream can be returned to the aquaculture holding tank 410 as at reference numeral 390 or reintroduced in the aquaculture process at any suitable point.

It has been found, quite unexpectedly that the process and device as disclosed herein can be employed to provide an effective method and device for killing bacteria and removing ammonia present in a process stream, more particularly when the process stream is a brine based system. The brine based process water stream is exposed to an electrolytic environment resulting in the production of sodium hypochlorite and hydrogen. When the sodium hypochlorite mixes with water it forms hypochlorous acid, which is measured as free chlorine. When free chlorine is combined with ammonia, it reacts to form chloramines such that the sum of the free chlorine generated plus the chloramines equals the total chlorine value for the process stream.

In various aquaculture operations, the food fed to the shrimp of fish is rich in nitrogen. The excess fish food contributes to elevated nitrogen levels in the process stream. When the nitrogen compounds are present a present in a bacteria-rich environment such as fish/shrimp feces, the nitrogen cycle proceed in which ammonia transforms to nitrates and nitrates are reformed into ammonia. The nitrogen rich environment is detrimental to the environment at large and to aquaculture production in particular. Removal of excess system nitrogen as measured by reduction in ammonia concentration will provide an aqueous environment that better supports aquaculture and reduces negative impact on the surrounding environment. It has been found, quite unexpectedly the electrolytic process as outlined results in conversion of ammonia to compounds such as chloramines. The high chlorine environment helps kill micororganisms such as bacteria and the like. Excess chlorine in the form of free chlorine as well as other chlorine compounds such as hypochlorous acid, chloramine and the like can be removed by carbon filtration or other suitable mechanism prior to reintroduction into the surrounding aqueous environment.

It is also contemplated that the electrodes in the reaction chamber assembly 10 can be configured to self-clean in the manner and configuration previously outlined. It is also with in the purview of this disclosure that the electrodes to be cleaned can be exposed to one or more of a variety of wash solutions that can be introduced as circulated in the reaction chamber assembly 10. The type and composition of the wash solution can vary depending on the nature of the build-up and deposition on the electrode surface which can be dependent on the make-up of the process stream under treatment. Thus each reaction chamber assembly 10 can also include appropriate vales and conduits to isolate the reaction chamber from process flow and receive wash solution as required.

Although embodiments have been described above with reference to the accompanying drawings, those of skill in the art will appreciate that variations and modifications may be made without departing from the scope thereof as defined by the appended claims.

1. A water remediation treatment device and system comprising:
at least one water treatment/remediation reactor unit, the water treatment/remediation reactor unit having a housing the housing having a cylindrical side wall a top member connected to the cylindrical side wall and a base connected to the cylindrical side wall as a location opposed to the top member, the housing defining a reaction chamber accessible by a process fluid inlet assembly and a process fluid outlet, means for defining a process fluid flow path within the housing in fluid communication with the process fluid inlet assembly, and an electrode array operatively positioned in the fluid flow path, the electrode array connected to the housing at a location proximate to the top member and extending downward therefrom, wherein at least a portion of the electrode array is oriented in a circular or semicircular relationship relative to the top member and is oriented at an angle relative to the fluid flow path, the electrode array functioning either anodically or cathodically depending on suitable inputs.

2. The device of claim 1 wherein the electrode array comprises a plurality of elongated electrodes, the elongated electrodes connected to the electrode array in a spaced elongated relationship to one another, where in the electrode array is connected to an electric source configured to deliver electric current at a value sufficient to permit the electrodes to operate at a current value between 20 amps and 350 amps and between 1 and 60 volts.

3. The device of claim 1 wherein the electrode array is composed of a plurality of elongated electrodes, the elongated electrodes position in side to side relation to one another in a radial spiral having at least two wraps.

4. The device of 3 wherein the at least a portion of the electrodes are connected to one another by a non-conductive spacer member interposed between side edges of respective electrodes.

5. The device of claim 3 wherein at least a portion of the electrodes are configured with a longitudinally curved central region.

6. The device of claim 5 wherein the electrodes are configured with longitudinally curved central regions are oriented in alternating opposed relationship to one another.

7. The device of claim 1 wherein the further comprising a reactive gas inlet tube, the reactive gas inlet tube extending from a point exterior to the housing to a point interior thereto, at a location proximate to the base of the housing, the inlet tube having plurality of nano/microbubble generating exit ports defined therein, where at least a portion of the reactive gas inlet tube has a configuration that corresponds to the portion of the electrode array is oriented in a circular or semicircular relationship.

8. The device of claim 8 wherein the housing further comprises a contaminant collection zone and a settlement region, the contaminant collection zone located between the electrode array and the top member and the settlement region located between the reactive gas inlet tube and the base,

9. The deice of claim 8 wherein the electrode array comprises a plurality of elongated electrodes, the elongated electrodes connected to the electrode array in a spaced elongated relationship to one another, where in the electrode array is connected to an electric source configured to deliver electric current at a value sufficient to permit the electrodes to operate at a current value between 20 amps and 350 amps and between 1 and 60 volts.

10. A method for remediating water comprising the steps of:
filtering a volume of water removed from process stream source to remove at least a portion of solid material entrained therein, wherein the removed solids having an average particle size greater about 30 micrometers;
introducing the filtered process stream to an electrofloatation environment, the electrocoagulation environment including at least one set of electrodes, wherein the electrocoagulation reduces concentration of at least one electrochemically reactive target compound present in the process stream;
after exiting the electrocoagulation environment, exposing the process stream to contact with dissolved gas in a pressure regulated environment for an interval sufficient to permit admixture of the dissolved gas with at least one gas-reactive target compound present in the process stream; and
separating at least a portion of the gas-reacted solids from the process stream upon exit from the pressure-regulated environment.

11. The method of claim 10 further comprising the steps of:
after separation of the at least a portion of the gas reacted solids from the process stream, exposing the process stream sequentially to the following:
a. contact with at least one of a fibrous and/or granular material for an interval sufficient to remove particulate material having a particle size less than 100 micrometers;
b. contact with a granulated carbonaceous material for an interval sufficient to remove at least one chlorine, sediment, and/or volatile organic compounds from the process stream.

12. The method of claim 11 further comprising the step of:
after the exposure step, conveying at least a portion of the process stream to at least one of the following: the aquaculture holding tank; at least one effluent outlet.

13. The method of claim 10 wherein the electrofloatation environment is a water remediation treatment device, the water remediation treatment device comprising:
at least one water treatment/remediation reactor unit, the water treatment/remediation reactor unit having a housing the housing having a cylindrical side wall a top member connected to the cylindrical side wall and a base connected to the cylindrical side wall as a location opposed to the top member, the housing defining a reaction chamber accessible by a process fluid inlet assembly and a process fluid outlet, means for defining a process fluid flow path within the housing in fluid communication with the process fluid inlet assembly, and an electrode array operatively positioned in the fluid flow path, the electrode array connected to the housing at a location proximate to the top member and extending downward therefrom, wherein at least a portion of the electrode array is oriented in a circular or semicircular relationship relative to the top member and is oriented at an angle relative to the fluid flow path, the electrode array functioning either anodically or cathodically depending on suitable inputs.

14. The method of claim 13 wherein the electrode array comprises a plurality of elongated electrodes, the elongated electrodes connected to the electrode array in a spaced elongated relationship to one another, where in the electrode array is connected to an electric source configured to deliver electric current at a value sufficient to permit the electrodes to operate at a current value between 20 amps and 350 amps and between 1 and 60 volts.

15. The method of claim 14 water treatment/remediation reactor unit further comprises a reactive gas inlet tube, the reactive gas inlet tube extending from a point exterior to the housing to a point interior thereto, at a location proximate to the base of the housing, the inlet tube having plurality of nano/microbubble generating exit ports defined therein, where at least a portion of the reactive gas inlet tube has a configuration that corresponds to the portion of the electrode array is oriented in a circular or semicircular relationship.
